(19) United States
(12) Patent Application Publication
(10) Pub. No.: US 2008/0055186 A1
(43) Pub. Date: Mar. 6, 2008

(54) ENCLOSURES WITH INTEGRATED ANTENNAS THAT MAKE USE OF THE SKIN EFFECT

(76) Inventors: Frederick O. Fortson, Whitmore Lake, MI (US); Greg Soosik, Canton, MI (US); Richard Hansen, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/757,754

(22) Filed: Jun. 4, 2007

Related U.S. Application Data
(60) Provisional application No. 60/810,681, filed on Jun. 2, 2006.

(51) Int. Cl. H01Q 1/40

(52) U.S. Cl. 343/873

(57) ABSTRACT

A thin layer or layers of electrically conductive material applied to the exterior surface of the enclosure exploits the skin effect for antenna implementations. Using an additive manufacturing process of the type wherein layers of material are consolidated without melting the material in bulk, at least the electrical interconnection may be completely embedded within the wall of the enclosure. Indeed, the transmitter, receiver, or transceiver and the electrical interconnection may also be completely embedded within the enclosure or the wall thereof. A pair of antennas may be provided to function as a dipole, for example. Alternatively, a plurality of antennas arranged to facilitate frequency tuning, beam steering, or other parameters. The antenna and enclosure are preferably fabricated from materials having different dielectric constants, including different metals. As examples, the enclosure may be fabricated from aluminum or stainless steel, while the antenna layer(s) may be fabricated from copper, gold, silver or other highly conductive materials. Antennas according to the invention may be used at microwave frequencies, including those used for wireless networking.

### REFERENCE TO RELATED APPLICATION

This application claims priority from U.S. Provisional Patent Application Ser. No. 60/810,681, filed Jun. 2, 2006, the entire content of which is incorporated herein by reference.

### FIELD OF THE INVENTION

This invention relates generally to electronic enclosures and, in particular, to consolidated enclosures with integrated antennas that rely upon the skin effect.

### BACKGROUND OF THE INVENTION

There are many instances where it is desirable to encapsulate a transmitter, receiver or transceiver in a tamper-proof enclosure. In such cases, an external antenna is often necessary for a sufficient degree of performance.

A problem with existing antennas is that they penetrate through the enclosure, resulting in “leak points” through which an unauthorized individual can open the enclosure or gather information about its contents.

### SUMMARY OF THE INVENTION

This invention solves problems associated with tampering by providing an enclosure concealing transmit/receive electronics with a thin layer or layers of electrically conductive material applied to the exterior surface of the enclosure, thereby talking advantage of the skin effect for antenna implementations. In the preferred embodiment, the various materials forming the enclosure and/or antenna are applied using an additive manufacturing process such as ultrasonic consolidation.

The preferred embodiment includes an enclosure with a wall including a transmitter, receiver, or transceiver; at least one area of material disposed on the outer surface of the enclosure, thereby forming an antenna that relies upon the skin effect; and an electrical interconnection between the antenna and the transmitter, receiver, or transceiver.

Using an additive manufacturing process of the type wherein layers of material are consolidated without melting the material in bulk, at least the electrical interconnection may be completely embedded within the wall of the enclosure. Indeed, the transmitter, receiver, or transceiver and the electrical interconnection may also be completely embedded within the enclosure or the wall thereof.

The invention is not limited in terms of the number, size or shape of the antenna pattern used. A pair of antennas may be provided to function as a dipole, for example. Alternatively, a plurality of antennas arranged to facilitate frequency tuning, beam steering, or other parameters.

The antenna and enclosure are preferably fabricated from materials having different dielectric constants, including different metals. As examples, the enclosure may be fabricated from aluminum or stainless steel, while the antenna layer(s) may be fabricated from copper, gold, silver or other highly conductive materials.

An advantage of the inventive configuration is that the antenna may be DC grounded, even at microwave frequencies, including 2.4 GHz or other frequencies used for wireless networking.

### BRIEF DESCRIPTION OF THE DRAWINGS

FIG. 1 is a perspective-view drawing that shows how a “patch” of material comprising an antenna may be a single area, or, with multiple regions, on an enclosure to form dipole or other antenna configurations in conjunction with enclosed electronics; and

FIG. 2 is a side-view cross-section showing how additive manufacturing techniques such as ultrasonic consolidation may be used to make an enclosure such that signal lines to/from the antenna patches may be entirely enclosed.

### DETAILED DESCRIPTION OF THE INVENTION

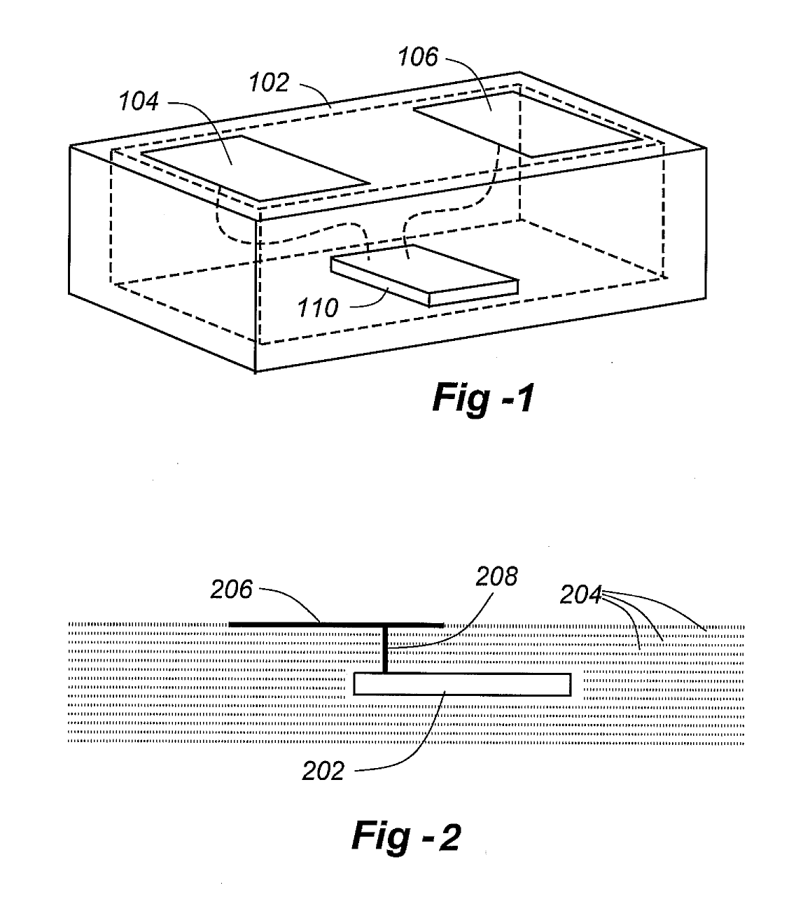

As shown in FIG. 1, a “patch” of material comprising an antenna may be a single area, or, with multiple regions, 104, 106 on the enclosure 102, dipole and other antenna configurations may be achieved in conjunction with enclosed electronics 110.

Furthermore, by providing a plurality of patches, antenna systems that support frequency-agile applications may be produced, including configurations affording greater bandwidth, while producing or eliminating frequency nulls. With sufficient patch areas, including patches of different sizes or geometries, frequency tuning and/or steering may be achieved. For example, an array pattern or one or more spirals may be implemented.

According to the invention, as long as the layers of patch material have a different dielectric constant than the material forming the enclosure, radiation will be achieved or detected through the skin effect, even if all-metal systems are used. For example, if the antenna patches are fabricated from a highly conductive material such as copper, gold or sliver, the enclosure may be aluminum, stainless steel or other material less electrically conductive and the antenna will still function, particularly at high frequencies. For example, at microwave frequencies, the skin effect dominates in terms of the mode of signal propagation. Depending on the size of the patch or patches used, the antenna may be tuned or geared toward particular frequencies, such as 2.4 gigahertz or other frequencies of interest.

Another important aspect of the inventive antenna patterns is due to the fact that they are DC-grounded. As such, certain antennas at certain frequencies which currently require a radome may be implemented without the radome, such as antennas associated with global positioning satellite (GPS) reception.

Referring to FIG. 2, in the event that additive manufacturing techniques such as ultrasonic consolidation is used to make the enclosure, signal lines to/from the antenna patches may be entirely enclosed. Indeed, the electronics 202 itself may be embedded within consolidated layers 204 of metal, thereby achieving an extremely tamper-proof component. The patches used to form the antenna pattern 206 (or patterns) and/or feedthrough 208 may be applied using the same consolidation process.

Commonly assigned U.S. Pat. No. 6,814,823, the entire content of which is incorporated herein by reference, describes a system and a method of fabricating a three-dimensional objects through the consolidation of material increments in accordance with a description of the object. The system uses a process that produces an atomically clean faying surface between the increments without melting the material in bulk. A CAD system interfaces with a numerical controller which controls an actuation system so that the ultrasonic consolidation of the layers takes place according to the CAD description of the object. In alternative embodiments, electrical resistance, frictional welding and laser cladding methodologies may be used for object consolidation according to this invention.

We claim:

1. An electronics assembly, comprising:
an enclosure with a wall including a transmitter, receiver, or transceiver;
at least one area of material disposed on the outer surface of the enclosure, thereby forming an antenna that relies upon the skin effect; and
an electrical interconnection between the antenna and the transmitter, receiver, or transceiver.

2. The electronics assembly of claim 1, wherein the enclosure is fabricated using an additive manufacturing process of the type wherein layers of material are consolidated without melting the material in bulk.

3. The electronics assembly of claim 2, wherein at least the electrical interconnection is completely embedded within the wall of the enclosure.

4. The electronics assembly of claim 2, wherein the transmitter, receiver, or transceiver and the electrical interconnection are completely embedded within the wall of the enclosure.

5. The electronics assembly of claim 1, including a pair of antennas functioning as a dipole.

6. The electronics assembly of claim 1, including a plurality of antennas arranged to facilitate frequency tuning.

7. The electronics assembly of claim 1, including a plurality of antennas arranged to facilitate beam steering.

8. The electronics assembly of claim 1, wherein the antenna and enclosure are fabricated from materials with different dielectric constants.

9. The electronics assembly of claim 8, wherein the antenna and enclosure are fabricated from different metals.

10. The electronics assembly of claim 1, wherein the enclosure is fabricated from aluminum or an alloy thereof.

11. The electronics assembly of claim 1, wherein the enclosure is fabricated from stainless steel.

12. The electronics assembly of claim 1, wherein the antenna is fabricated from copper.

13. The electronics assembly of claim 1, wherein the antenna is fabricated from gold or silver.

14. The electronics assembly of claim 1, wherein the antenna is DC grounded.

15. The electronics assembly of claim 1, wherein the antenna operates at microwave frequencies.

16. The electronics assembly of claim 1, wherein the antenna operates at 2.4 GHz or thereabouts.
